(19) United States
(12) Patent Application Publication
(10) Pub. No.: US 2012/0034682 A1
(43) Pub. Date: Feb. 9, 2012

(54) Process for Separating High Purity Germ and Bran from Corn

(76) Inventors: John Didion, Cambridge, WI (US); Todd J. Giesfeldt, Madison, WI (US); Jon Bortz, Cambria, WI (US)

(21) Appl. No.: 13/273,572

(22) Filed: Oct. 14, 2011

Related U.S. Application Data
(62) Division of application No. 12/369,287, filed on Feb. 11, 2009.

(51) Int. Cl. C12S 3/00

(52) U.S. Cl. 435/267

(57) ABSTRACT

A semi-wet process for refining corn to make a feedstock for ethanol production. Corn is tempered at a moisture content from about 20-25% by weight for a very short time followed by grinding. The ground corn is not dried and cooled before further processing. It is graded and then ground and sifted to make an endosperm fraction and a high purity fraction of germ and bran. The fraction of germ and bran can be separated in a one or two stage dry separation process or in a wet separation process. In the wet separation process, the fraction of germ and bran is enzymatically steeped, dewatered and then separated in hydrocyclones to produce a germ fraction and a bran fraction.

### BACKGROUND OF THE INVENTION

1. Field of the Invention

The present invention has to do with a new process for refining corn to make feedstock for an ethanol fermentation process. The process separates tempered corn into an endosperm fraction and a fraction of high purity germ and bran. The germ and bran fraction can be separated in a conventional or modified dry process or in a new wet separation process which separates the germ and bran and removes remaining endosperm.

2. The Related Art

Corn refining by dry and wet milling processes has traditionally been directed to making food grade flour, starch and other products. As the demand for ethanol as a fuel and a fuel additive has grown, the demand for more cost effective and environmentally friendly corn refining processes has increased. The present invention addresses this demand.

In U.S. Patent Application Publication No. US2007/0202214 A1 a method for producing ethanol using raw starch and fractionation is disclosed. The method can include employing fractionated plant material with a particle size such that more than 50% of the material fits through a sieve with a 0.5 mm mesh. A conventional process is generally described for fractionating vegetable material such as corn.

U.S. Pat. No. 4,181,748 describes a continuous process for refining whole grain corn employing dry milling to fractionate the corn followed by wet miffing the endosperm fraction. Corn oil is optionally separated from the corn germ fraction prior to further processing. The product of the process is animal feed.

High protein distillers dried grains are made according to U.S. Pat. No. 6,962,722 from a corn endosperm fraction of a dry milling process. The first step in the process is described as tempering clean corn with water at a moisture content from 17% to 20% percent for a period of from 10 minutes to 2 hours. The tempered kernels are than dehulled and degerminated followed by drying prior to further processing.

All percentages set forth herein are by weight/weight unless otherwise specified.

The term “sent to” is defined herein as any suitable method of conveying process material from one stage of a process to another such as by pumping, gravity feed, pressurized air and the like.

### SUMMARY OF THE INVENTION

Corn kernels are cleaned and then tempered in two stages. In the first tempering stage the moisture content of the cleaned corn is increased by the admixture of water to a total moisture content by weight of about 15% to 19%, preferably from about 17% to 18%, and held for less than about 10 minutes. The second tempering stage increases the total moisture content by weight to from about 20% to 25%, preferably from about 20% to 23%, by spraying water on the corn just prior to grinding. Thus, the corn is only tempered at the about 20% to 25% (preferably about 20% to 23%) moisture level for from about 1 second to about 1 minute to prepare tempered corn for fractionation. This is in sharp contrast to the prior art wherein a long holding time, anywhere from one hour to two days, is believed necessary for the water to do an effective job of preparing the corn for fractionation.

The tempered corn is fractionated by grinding, then grading and then sifting without drying or cooling the ground corn prior to sifting. Thus, fractionating is done at high moisture to produce a fraction of endosperm which is sent to ethanol production and a fraction or fractions which are sent to one or more than one germ section for grinding and sifting to produce high purity fractions of germ and bran and additional endosperm fractions. The fractions of endosperm contain some bran and some germ but these fractions are suitable as a feedstock to an ethanol fermentation process. Previously known processes emphasize the production of a high purity endosperm fraction in direct contrast to the process of the present invention.

The fractions of germ and bran are then subjected to a separation process. This can be a conventional dry separation process using an aspirator. Alternatively, a two-stage modified dry process can be used as described in more detail below.

In a preferred embodiment, the fractions of germ and bran are separated using a new wet separation process employing process water and the still bottom slurry from the ethanol fermentation process. The fractions are combined in a germ and bran collection vessel and first steeped with the process water and enzyme for a total steep time from about 150 minutes to about 330 minutes, preferably from about 225 minutes to about 260 minutes. The process water is added in an amount sufficient to adjust the percent solids to from about 8% to 16% and steeping is preferably carried out in two steps. The first step is carried out at about 175° F. to 185° F. for from about 30 minutes to about 90 minutes, preferably from about 55 minutes to about 70 minutes, using alpha amylase and this is followed by a second step at about 85° F. to 95° F. for from about 120 minutes to about 240 minutes, preferably from about 170 minutes to about 190 minutes, using glucoamylase. Total steep time is then about 4 hours. The two enzymes give a better result than alpha amylase or glucoamylase alone. According to U.S. Pat. No. 6,899,910, the alpha amylase could be added alone for a single steeping step at 180° F. or in a two step steeping process using alpha amylase and glucoamylase. But we have found that two step steeping is preferred because it maximizes the efficiency of each enzyme and a shorter steeping time can be used.

The two step steeping process is accomplished in the plant with 4 tanks. The first tank is a fill tank. The second tank is for the alpha amylase steeping step. Following alpha amylase steeping, the fraction is cooled, preferably by a heat exchanger, and transferred to a third tank for glucoamylase steeping. The fourth tank is a holding tank for the steeped product. Suitable enzymes for steeping include Novozymes LIQUOZYME SC DS alpha-amylase and Genencor G-ZYME 480 ethanol glucoamylase. The alpha-amylase steeping is conducted at a pH from about 5 to 6, preferably about 5.5, and the glucoamylase steeping is conducted at a pH from about 4 to 5, preferably about 4.5. The objective of steeping is to liquefy the free starch so starch fragments split with the water and to reduce the total remaining starch to less than about 10% (bound+free starch) in the bran and germ. Ideally, the goal is to solubilize all of the free starch and as much bound starch as possible. This is followed by admixing the still bottom slurry to make an admixture having a density from about 7 to 10 Baumé, preferably from about 8 to 9.5 Baumé. The admixture is fed to a germ and bran separation process employing hydrocyclones.

The still bottom slurry made in an ethanol plant with feedstock from the process of our invention has a low oil content compared with still bottom slurries taken from ethanol fermentation processes employing more conventional feedstocks. This is because the feedstock produced by the process of our invention, namely, the endosperm fractions, has a low oil content. Most of the oil stays with the germ in our high purity germ and bran fractions. Therefore, the still bottom slurry has an oil content of from about 4% dry basis oil to about 9% dry basis oil, preferably from about 6% dry basis oil to about 7% dry basis oil. When the germ and bran fraction is admixed with the still bottom slurry, the high oil content of the germ relative to the low oil content of the still bottom slurry causes the germ to float and facilitates removal of the germ. Stated another way, the germ floats to the top and is separated from the bran which falls to the bottom. We note that the high oil content of the germ fraction is another benefit of our invention because it enhances oil recovery in the germ press.

### BRIEF DESCRIPTION OF THE DRAWINGS

FIG. 1 is a block diagram of the tempering, grinding and grading processes of the invention.

FIG. 2 is a block diagram of a conventional dry process for separating germ and bran.

FIG. 3 is a block diagram of a two-stage process for separating germ and bran.

FIG. 4 is a block diagram of the wet process for separating germ and bran.

FIG. 5 is a block diagram of the overall process employing the wet process for separating germ and bran.

### DESCRIPTION OF THE PREFERRED EMBODIMENT

A traditional dry mill takes corn grain, grinds it and mechanically separates the three major components—endosperm, germ and bran. The goal is to make one percent fat endosperm. Therefore, some endosperm must go with the germ and bran, since pure separations cannot be made by mechanical separation. The roller mills and sifters are typically arranged in three sections, a break section, a germ section and a reduction section. The main elements are in the break section wherein the roller mills grind pretty hard. The next section is the germ section which handles a smaller, higher fat throughput with rolls that are set to cause less severe grinding so as not to damage the germ. Finally, the material is passed through the reduction rolls which are set for even finer grinding to make finer meals and more flour.

Another traditional process is the semi-dry process. In this case, some water is added to the grain before grinding to allow semi-dry grinding as opposed to wet grinding done in a wet mill. Semi-dry grinding does a better job of separating the fractions because the semi-dry germ and bran survive the grinding step better (i.e., in bigger pieces). Following the grinding step, all of the ground material is dried and cooled for further processing. The germ is then typically removed with concentrators and the remaining germ in the endosperm is separated with a combination of roller mills and sifters. The brand is taken off along the way with aspirators.

We have found a way to advantageously modify the semi-dry process when the output of the corn refining process is going to ethanol production. In our process, which we shall refer to herein as a semi-wet process, we add water to the grain to a high moisture content for a short temper time before grinding. This enables us to get the same benefit in the ground products as semi-dry grinding because the germ and bran survive the grinding step better, in bigger pieces. Following grinding, we do not dry and cool the material before further processing.

Because we keep the temper time so short, the water does not penetrate the vitreous (hard endosperm) instead, the water stays with the fines going direct to ethanol, and with the bran and germ going to a separation process. Our modified process uses less energy because we are not concerned with low moisture and that is the reason why we don't have to dry and cool. In fact, we operate the process at the highest moisture possible that will still allow us to get the material through the process equipment. We also use substantially less process air, an energy saving and environmentally friendly improvement over the art.

According to our preferred embodiment, we temper the corn to about 20% to 25%, preferably about 20% to 23%, total moisture by putting most of the added moisture on the corn as a spray just before grinding. These moisture levels are considered to be high moisture relative to the moisture content employed in a traditional dry milling process. We do not dry or cool the ground corn. We just continue to process it. The ground corn is graded into fractions as follows:
i) a first ground corn fraction having a mesh size from about +10 to +4 mesh, preferably about +8 to +5 mesh and most preferably about +7 to about +6 mesh,
ii) a second ground corn fraction having a mesh size from about −10 to about −4 mesh, preferably about −8 to −5 mesh and most preferably about −7 to about −6 mesh, to from about +20 to about +10 mesh, preferably from about +16 to about +12 mesh and most preferably from about +14 to about +12 mesh and
iii) an endosperm fraction having a mesh size from about −20 to about −10 mesh, preferably from about −16 to about −12 mesh and most preferably from about −14 to about −12 mesh,
   it being understood that the first ground corn fraction will be more coarse than the second ground fraction. For example, if the screen used to make the first ground corn fraction is a 10 mesh screen, the second screen will have a size of less than 10 mesh, such as 12 mesh or 14 mesh or smaller.

In the embodiment illustrated in the drawings and discussed below the ground corn is graded into a +7 mesh first ground corn fraction, a −7+12 mesh second ground corn fraction and a −12 mesh endosperm fraction. The +7 mesh first ground corn fraction goes to a first germ section for grinding and sifting and the −7+12 mesh second ground corn fraction goes to a second germ section for grinding and sifting. A fraction of germ and bran and a fraction of endosperm is produced by each germ section.

We have used the term “germ section” to define an apparatus comprised of a grinder followed by at least one sifter. As grinders in the germ sections we use roller mills and as sifters we use gyrating, single pass, all metal sifters such as those made by ROTEX, Model 523S AASS or Model 842S AASS modified for high moisture product, and equipped with 2 or 3 stainless steel screens. We also use SWECO GyraMax™ Model GSD-510SL and Model GDS-612SL, which we modified slightly by removing obstructions from the bottom tray and increasing the size of the bran/germ discharge to handle the large size particles. The SWECO has about twice the pitch (vertical drop from inlet to outlet) 6 degrees vs. 3 degrees for the ROTEX, which aids in high moisture sifting. The ROTEX equipment is available from ROTEX Inc., 1230 Knowlton Street, Cincinnati, Ohio 45223 U.S.A. and the SWECO equipment is available from SWECO DIVISION OF M-I, 8029 U.S. Highway 25, Florence, Ky. 41022 U.S.A.

We use a gyrating all metal sifter because it does a good job of handling high moisture as compared with a wood plan sifter. The gyrating ROTEX/SWECO style works well in this application.

The material passing through the 12 mesh sifter can go directly to the ethanol fermentor without further processing. In a refinement of the process some of the material can be ground to less than about 20 mesh. When we have less than 12 mesh fines from the initial separation they can be too wet to roller mill, in which case we run them through a hammer mill.

The fractions of germ and bran made by our process are high purity fractions (i.e., low in starch). The endosperm fractions contain some germ and bran but are suitable for use in ethanol production and these fractions are sent directly to ethanol production. Our germ and bran fractions can be separated in one of the dry separation processes described in this specification or in our new wet separation process.

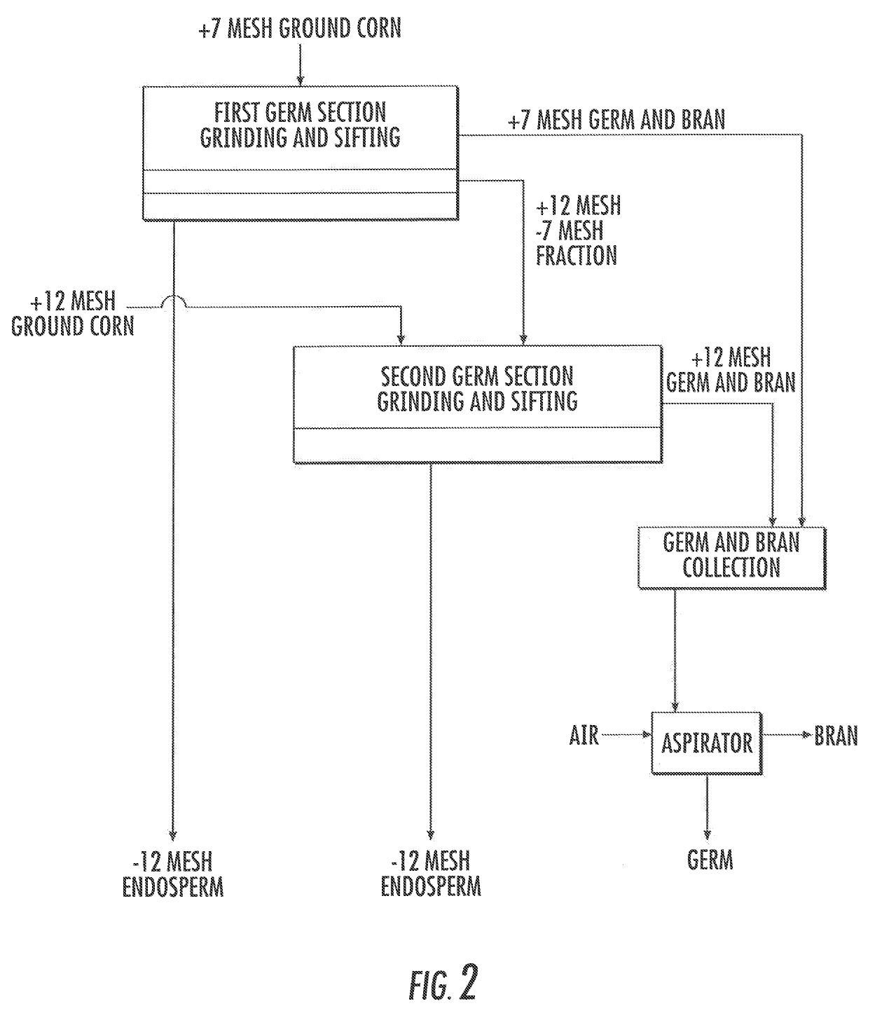

In one dry separation process, both of the germ and bran fractions are combined and sent to an aspirator such as a Kice multipass aspirator or a Buhler aspirator. This is illustrated in FIG. 2. In the aspirator, an air stream lifts the bran away from the germ, creating a bran stream and a germ stream.

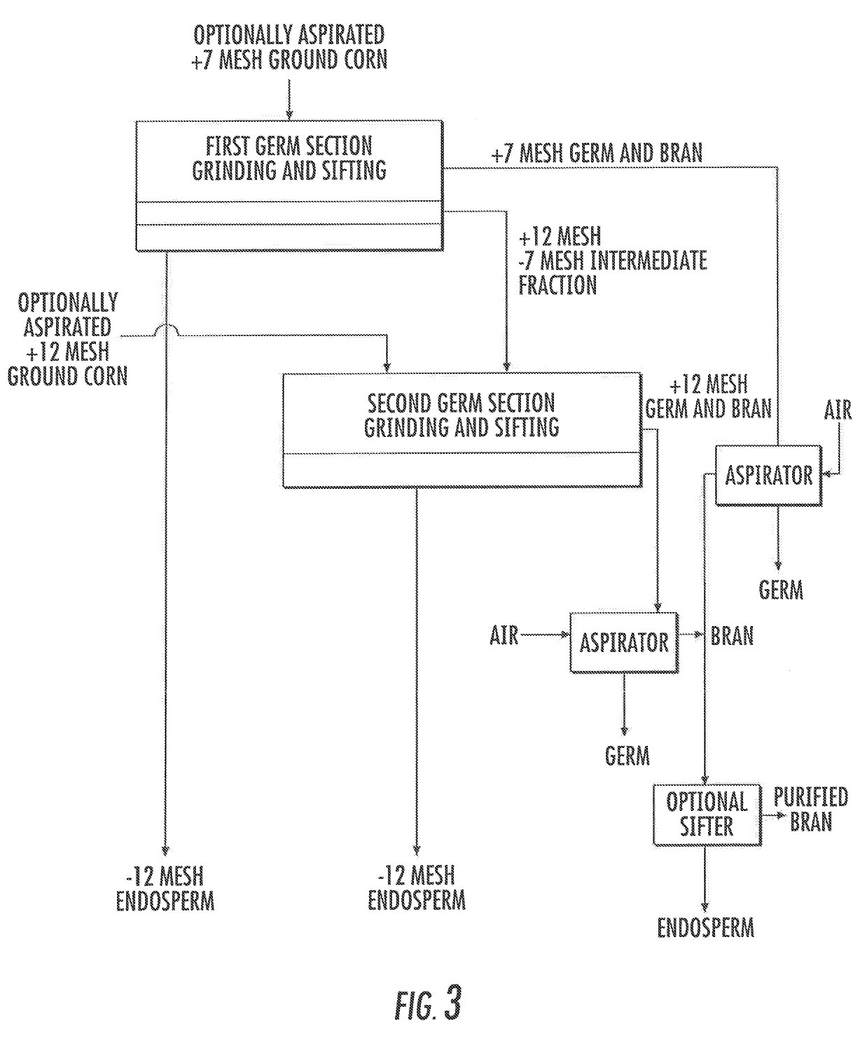

In an alternative dry separation process the supply to the first germ section and/or the supply to the second germ section is optionally aspirated to separate some of the bran. Then we separately aspirate the +7 mesh germ and bran produced by the first germ section and the +12 mesh germ and bran produced by the second germ section, thus creating a two-stage bran removal process. This is illustrated in FIG. 3. Thus, each aspirator produces a germ fraction and a bran fraction. With this approach, the bran fractions are combined and optionally sent to a sifter to remove the fines (mainly endosperm). The advantage is a reduced load on the roller mills, and the sifters. The disadvantage is yield loss (attached endosperm leaving with the bran, assuming the bran goes to feed).

The germ is dried down to 4-5% and sent to a germ press (i.e., oil expellers). The oil is recovered, and the solids from the press (press cake and foots) are then fed into the ethanol process wet up tank and fermented along with the rest of the endosperm. Doing so recovers the starch in the germ solids, supplies the oil needed for good fermentation, and supplies yeast nutrients. When this process is followed, the press cake is much lower in starch than endosperm.

In the wet germ and bran separation process, both of the germ and bran fractions are combined before processing.

The figures are provided to better illustrate the embodiments of the invention and they are described as follows:

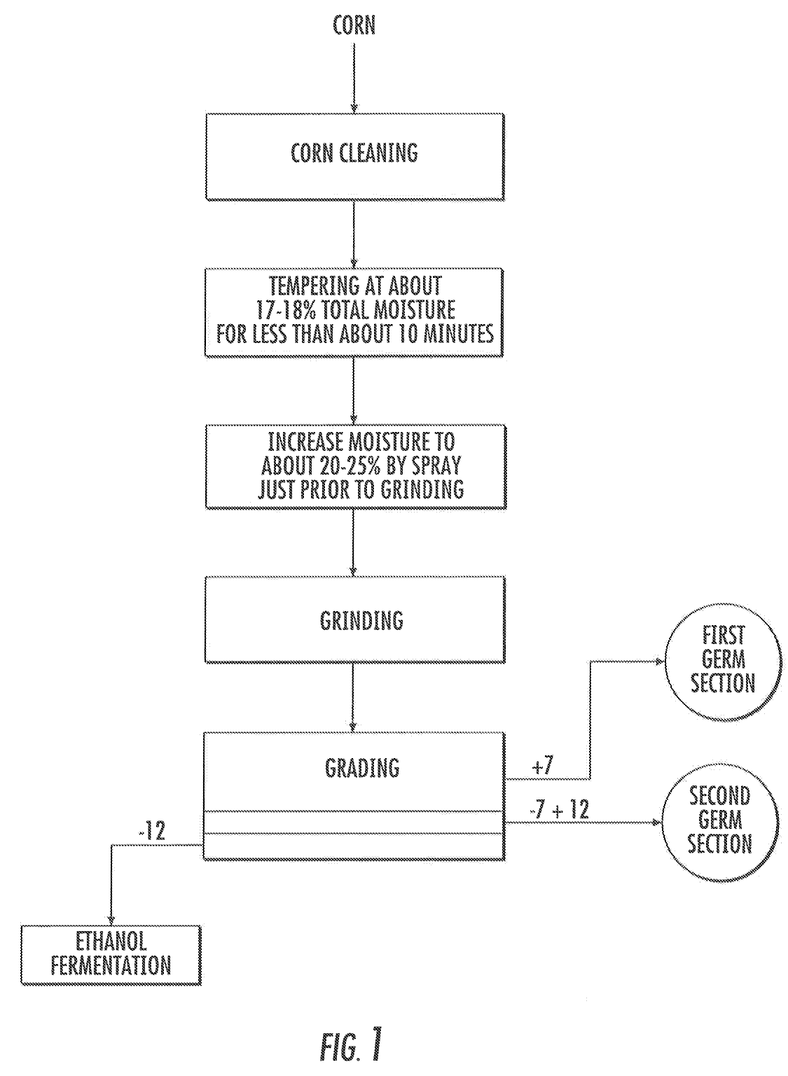

FIG. 1 illustrates the degermination and roller milling/sifting corn refining process of the invention in a simplified block diagram. As explained above, the process is conducted at a high moisture content in order to obtain a high purity fraction of germ and bran.

FIGS. 2 and 3 illustrate the dry processes for separating germ and bran as discussed above.

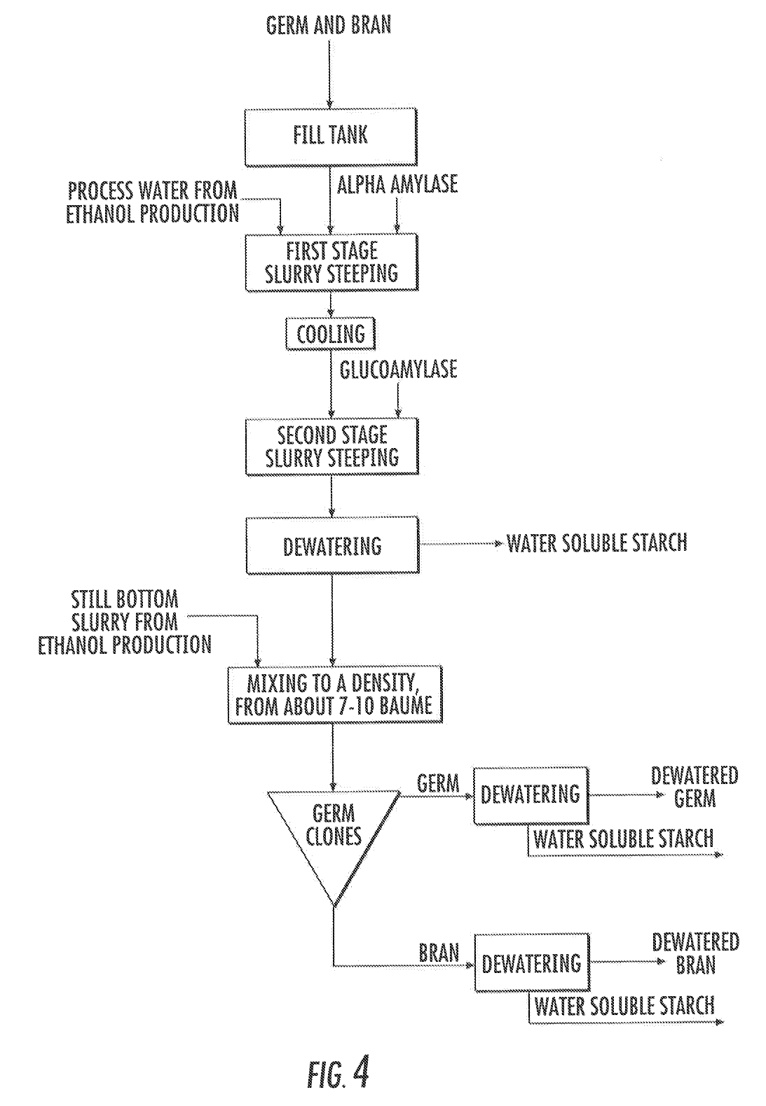

FIG. 4 illustrates the wet process for separating germ and bran from the high purity germ and bran fractions. The process requires process streams from an ethanol fermentation process. One stream is the process water, also called backset water or thin stillage, and this is used to steep the germ and bran fraction. The other stream is the low oil content still bottom slurry. This is used to adjust the density of the steeped germ and bran fraction to from about 7 to about 10 Baumé, preferably from about 8 to about 9.5 Baumé to make it suitable for separation of the germ from the bran in hydrocyclones. We typically use 6 or 8 inch diameter hydrocyclones with a pressure differential across each hydrocyclone of about 20 to about 80 pounds per square inch (“psi”), preferably about 40 to about 50 psi and most preferably about 45 psi.

As illustrated in FIG. 4, the germ and bran fractions are collected in a fill tank. Material from the fill tank is sent to a first stage slurry steeping tank where process water from ethanol production and alpha amylase are admixed with the germ and bran and steeping is conducted to liquefy the free starch. This steeping step is conducted for from about 30 minutes to about 90 minutes, preferably from about 55 minutes to about 70 minutes, at a pH from about 5 to 6, preferably about 5.5, and a temperature from about 175° F. to about 185° F., preferably about 180° F. Material from the first stage slurry steeping tank is cooled and sent to a second stage slurry steeping tank where it is admixed and steeped with glucoamylase for from about 120 minutes to about 240 minutes, preferably from about 170 minutes to about 190 minutes, at a pH from about 4 to 5, preferably about 4.5, and a temperature from about 85° F. to about 95° F., preferably about 90° F. The total stepping time is from about 150 minutes to about 330 minutes, preferably from about 225 minutes to about 260 minutes. Material from the second stage slurry steeping tank is dewatered to separate water soluble starch. A suitable apparatus for dewatering is a sluice screen. The water soluble starch is sent to the fermentor of the ethanol fermentation process.

The dewatered material from second stage slurry steeping is sent to a holding tank where it is admixed with a still bottom slurry from an ethanol fermentation process to make an admixture having a density from about 7 to 10 Baumé, preferably from about 8 to 9.5 Baumé This admixture is sent to germ clones to separate the germ from the bran. The germ is dewatered and the bran is dewatered to separate water soluble starch. The water soluble starch is sent to the fermentor of the ethanol fermentation process.

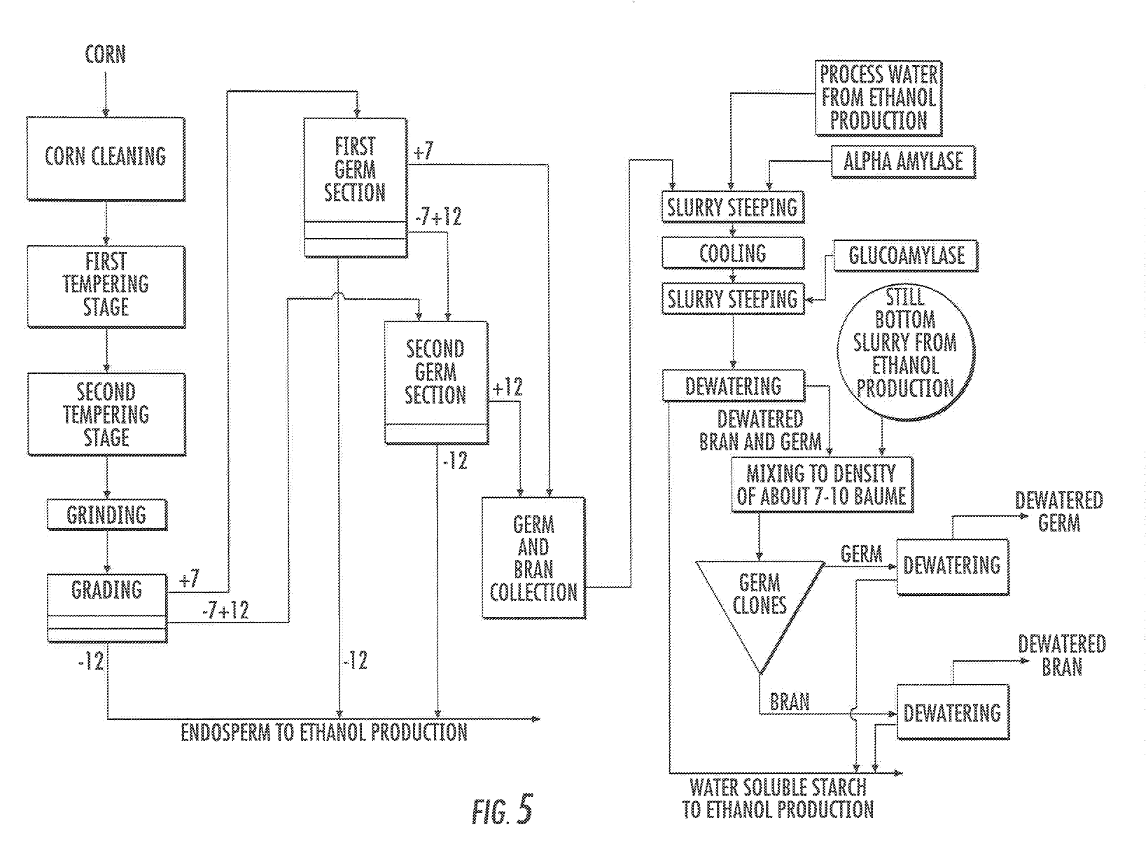

FIG. 5 illustrates a preferred embodiment of the overall process of the invention employing wet separation of germ and bran. Corn kernels are cleaned and the cleaned kernels generally have a total moisture content of about 12% to 15%. Water is added in a first tempering stage to bring the total moisture to about 17% to 18%. After tempering for less than about 10 minutes, preferably from about 4 to 8 minutes, more preferably from about 5 to 7 minutes, water is sprayed on to bring the total moisture content up to about 20% to 25%, preferably 20% to 23%. The tempered corn is promptly ground (degerminated) (e.g., in a Sturtevant impact mill) and then graded so that tempering at the total moisture content noted above is generally for less than about 1 minute, preferably from about 1 second to about 1 minute and more preferably from about 5 seconds to about 30 seconds.

Grading is done in a ROTEX or SWECO grader with 7 mesh and 12 mesh screens. Material passing through the 12 mesh screen, a −12 mesh fraction of endosperm, is sent directly to ethanol production. The +7 mesh fraction is ground and sifted by sending it to a first germ section comprised of a roller mill followed by a ROTEX or SWECO first germ sifter having 7 mesh and 12 mesh sifter screens. The first germ section produces three fractions. Material passing through the 12 mesh sifter is another −12 mesh fraction of endosperm and this fraction is sent to ethanol production. The +7 mesh fraction is finished germ and bran which is sent to germ and bran collection. The −7+12 mesh intermediate fraction from the first germ section is sent to a second germ section for further grinding by a roller mill and then sifting in a ROTEX or SWECO second germ sifter having 12 mesh sifter screens. The −7+12 mesh fraction from the grader is also sent to the second germ section. The second germ section produces another −12 mesh fraction of endosperm which is sent to ethanol production and the +12 mesh fraction is finished germ and bran which is sent to germ and bran collection. It should be noted in the foregoing description that we have defined material passing through 12 mesh screens or sifters at any stage of the process as an endosperm fraction and material going to germ and bran collection is defined as a high purity fraction of germ and bran.

No drying or cooling is used in the foregoing grinding, grading and sifting stages of our process. In previously known processes, drying is carried out with heated air and cooling is then carried out with ambient or cooled air following grinding and before further processing. Our process eliminates the use of this air and eliminates the energy and capital costs associated with heating and cooling the air and the product and evaporating water.

The high purity fractions of germ and bran are defined as such because they are low in starch. A benefit of the process of the invention is that the endosperm fraction is high in starch and this is beneficial to ethanol production.

In a preferred embodiment, wet process is employed to separate germ and bran from the high purity germ and bran fraction and to recover remaining free and bound starch as soluble starch fragments in the liquid phase. The fraction is steeped in two stages. In a first stage, process water from the ethanol production process is added to the fraction to adjust the percent solids to from about 8% to 16% and the fraction is mixed for from about 1 to 5 minutes to make a slurry. The fraction then is heated to about 175° F. to 185° F., preferably about 180° F., adjusted with sulfuric acid to a pH of about 5 to 6, preferably about 5.5, and from about 0.02% to 0.04% alpha-amylase is added. Steeping with mixing under these conditions is continued for from about 30 minutes to about 90 minutes, preferably from about 55 minutes to about 70 minutes. Then the fraction is cooled to about 85° F. to 95° F., preferably to about 90° F., the pH is adjusted with sulfuric acid to about 4 to 5, preferably about 4.5, and from about 0.02% to 0.04% glucoamylase is added. Steeping with mixing under these conditions is continued for from about 120 minutes to about 240 minutes, preferably from about 170 minutes to about 190 minutes, to maximize the solubilization of the starch. The slurry steeping process is also referred to as wet-up and liquefaction.

Liquefied material from this process is admixed with the low oil content still bottom slurry from the ethanol production process (as described above) to obtain an admixture having a density from about 7 to 10 Baumé preferably 8 to 9.5 Baumé or a dry solids content from about 8% to about 16%. This admixture is sent to germ clones which separate the germ and bran. The germ and bran streams can be processed further by conventional means.

An important aspect of our wet germ and bran separation process is that it eliminates the use of air. Conventional separation processes employ large quantities of air to concentrate and separate the germ using gravity tables. Bran is also separated out with air in conventional processes using aspirators. The only air employed in our semi-wet corn refining and wet germ and bran separation processes is for transport blowers and to suction off the equipment for dust control. This represents a small fraction, less than about one-tenth, of the air employed in previously known processes.

1-10. (canceled)

11. A continuous wet process for separating corn germ and bran comprising:
a) enzymatically steeping a corn germ and bran fraction obtained from a corn refining process to make a steeped germ and bran;
b) separating water and soluble starch from the steeped germ and bran to make a dewatered germ and bran fraction;
c) separating the dewatered germ and bran fraction into a germ fraction and a bran fraction;
d) separating water and soluble starch from the germ fraction; and
e) separating water and soluble starch from the bran fraction.

12. The process of claim 11 wherein steeping comprises admixing the germ and bran fraction with process water from an ethanol fermentation process to make a wet germ and bran fraction and then slurry steeping the wet germ and bran fraction with an enzyme to make the steeped germ and bran fraction.

13. The process of claim 11 wherein steeping comprises
a first step of admixing the germ and bran fraction with process water from an ethanol fermentation process and then slurry steeping with alpha amylase to make an alpha amylase steeped product and
a second step of slurry steeping the alpha amylase steeped product with glucoamylase.

14. The process of claim 12 wherein the dewatered germ and bran fraction is separated by admixing the fraction with a low oil content still bottom slurry from an ethanol fermentation process to make an admixture having a density from about 7 to 10 Baumé followed by introducing the admixture into a hydrocyclone to separate the germ and bran into a germ fraction and a bran fraction.

15. A continuous process for separating endosperm, germ and bran from corn comprising:
a) cleaning corn kernels to prepare cleaned corn;
b) tempering the cleaned corn by admixing water with the cleaned corn to a total moisture content of about 20-25% by weight to prepare tempered corn;
c) fractionating the tempered corn to make fractionated corn and, without cooling or drying, separating the fractionated corn into an endosperm fraction and fraction of germ and bran;
d) steeping the fraction of germ and bran to make a steeped germ and bran; and
e) separating the steeped germ and bran into a germ fraction and a bran fraction.

16. The process of claim 15 further comprising separating water and fines from the germ fraction and/or separating water and fines from the bran fraction.
